(19) United States
(12) Patent Application Publication
(10) Pub. No.: US 2005/0138674 A1
(43) Pub. Date: Jun. 23, 2005

(54) System and method for integration and synchronization of interactive content with television content

(75) Inventors: Daniel H. Howard, Atlanta, GA (US); James R. Harrell, Atlanta, GA (US); Paul D. Haynie, Atlanta, GA (US); James B. Langford JR., Calhoun, GA (US); Richard J. Protus, Smyrna, GA (US); Kevin W. Brown, Decatur, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: QUADROCK COMMUNICATIONS, INC, Atlanta, GA (US)

(21) Appl. No.: 11/013,504

(22) Filed: Dec. 15, 2004

Related U.S. Application Data
(60) Provisional application No. 60/530,526, filed on Dec. 17, 2003.

(51) Int. Cl. H04N 7/173; H04N 7/16; H04N 7/10; H04N 7/025

(52) U.S. Cl. 725/136; 725/135; 725/32

(57) ABSTRACT

A system and method for integration and synchronization of interactive content with television programming uses existing analog or digital television programming that is entirely devoid of interactive content, or can integrate legacy interactive content with fully interactive content to provide a complete interactive experience to television viewers of current and future television programming that is synchronized to the original television content.

### CROSS-REFERENCE TO RELATED APPLICATIONS

This application claims the benefit under 35 U.S.C. §119(e) of U.S. Provisional Patent Application Ser. No. 60/530,526 for “System and Method for Integration of Interactive Content with Television Content,” which was filed Dec. 17, 2003, and which is incorporated herein by reference in its entirety.

### BACKGROUND OF THE INVENTION

1. Field of the Invention

The present invention relates to television, and more particularly, to a system and method for the integration and synchronization of interactive content with analog and digital television programming.

2. Related Art

Interactive television (TV) has already been deployed in various forms. The electronic program guide (EPG) is one example, where the TV viewer is able to use the remote control to control the display of programming information such as TV show start times and duration, as well as brief synopses of TV shows. The viewer can navigate around the EPG, sorting the listings, or selecting a specific show or genre of shows to watch or tune to at a later time. Another example is the WebTV interactive system produced by Microsoft, wherein web links, information about the show or story, shopping links, and so on are transmitted to the customer premises equipment (CPE) through the vertical blanking interval (VBI) of the TV signal. Other examples of interactive TV include television delivered via the Internet Protocol (IP) to a personal computer (PC), where true interactivity can be provided, but typically only a subset of full interactivity is implemented. For the purposes of this patent application, full interactivity is defined as fully customizable screens and options that are integrated with the original television display, with interactive content being updated on the fly based on viewer preferences, demographics, other similar viewer's interactions, and the programming content being viewed. The user interface for such a fully interactive system should also be completely flexible and customizable.

No current interactive TV system intended for display on present-day analog or digital televisions provides this type of fully interactive and customizable interface and interactive content. The viewer is presented with either a PC screen that is displayed using the TV as a monitor, or the interactive content on the television screen is identical for all viewers. It is therefore desirable to have a fully interactive system for current and future television broadcasting where viewers can interact with the programming in a natural manner and the interactive content is customized to the viewer's preferences and past history of interests, as well as to the interests of other, similar viewers.

A key problem limiting the ability to deliver such fully interactive content coupled to today's analog TV programming is the lack of a system for integrating and synchronizing this fully interactive content with a digital or analog broadcast TV signal, especially if this interactive content is delivered via a communications channel other than the television broadcast. Currently, interactive TV content is limited to content delivered over systems with built-in synchronization systems such as the vertical blanking interval (VBI) of analog television signals, fully digital TV, or IP video. In addition, interactivity must be embedded in the original content at the source severely limiting the ability to provide a customized experience using broadcast delivery technology such as over-the-air, cable, or satellite systems. A system that integrates and synchronizes customized fully interactive content with analog or digital broadcast TV where the interactive content can be developed and delivered separately from the analog or digital television content is described in this patent.

### BRIEF SUMMARY OF THE INVENTION

The present invention is directed to a method and system for integrating and synchronizing non-embedded interactive content with live or recorded, analog or digital, TV programming in order to provide interactive TV that is personalized, customizable and dynamically altered in response to the TV programming, the viewer's preferences, history, and other viewer's inputs. In order to integrate and synchronize interactive content, a system for processing a variety of data related to the TV programming is described, with examples being existing data sent in the vertical blanking interval (including but not limited to closed caption text and other VBI data, as well as any specialized embedded data items), program guide databases combined with current or recorded date/time stamps, attributes of program audio, attributes of program video, and data directly from digital program sources.

In one aspect of the present invention there is provided a system for capturing and processing the vertical blanking interval (VBI) data that is typically transmitted along with television broadcasts. The processing outputs are then used to generate a synchronization marker related to what is happening in the television program at that moment during the program. These markers are used to synchronize the local version of the program with interactive content that is delivered to the system.

In another aspect, there is provided a method where an electronic program guide database is searched and processed to provide detailed information about the television program being watched or recorded. Current date and time or a recorded timestamp along with channel lineup information is used to correlate the target video with the program guide.

In another aspect, there is provided a method where the data associated with a digital version of television programming in for example MPEG2 or MPEG4 format, are processed to identify scene changes for segmentation of the television video and synchronization with interactive content delivered on a separate communications channel from the television program.

In another aspect, there is provided a method where the television program has a clearly defined start time associated with an image or sound event at the beginning of the program that can be used as a reference point, and from then on, an incrementing counter or timer is used to index frames, text, and other events in the television program for subsequent synchronization with interactive content that is delivered via a separate communications channel.

In another aspect, there is provided a method where the audio track of a television program is used to synchronize the program with interactive content. Example audio information that can be used includes, but is not limited to speech recognition of the audio track, sound volume level changes in the audio track, statistics and parameters of the sampled and processed audio track, and statistics and parameters of the sampled and compressed audio track such as bandwidth vs. time.

In another aspect, there is provided a method where the video portion of a television program is used to synchronize the program with interactive content. Example video information that can be used includes, but is not limited to image recognition of the sampled video frames, video signal level changes such as brightness or color, statistics and parameters of the sampled and processed video, and statistics and parameters of the sampled and compressed video such as bandwidth vs. time, and statistics of MPEG sub frames (I, B, P).

In another aspect, there is provided a method where the television program is received in either analog or digital format via a cable television system, a satellite television system, a terrestrial over-the-air broadcast television system or a packet-switched network.

In another aspect, there is provided a method where interactive content is generated and stored locally within the customer premises equipment.

In another aspect, there is provided a method where interactive content is generated at a remote site and transmitted to the customer premises equipment using a packet switched network. Once the interactive content arrives at the customer premises it may be immediately displayed or stored locally for later display.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE FIGURES

The present invention will be described with reference to the accompanying drawings. The drawing in which an element first appears is typically indicated by the leftmost digit(s) in the corresponding reference number.

FIG. 1 illustrates an overall network diagram for provision of fully interactive television content that is integrated with existing television broadcasts or stored programming. In this figure, elements of integration and synchronization of interactive content with television programming are contained both in central repositories and also in the customer premises equipment.

FIG. 2. illustrates an interactive TV content generator that may be in a central repository, in the customer premises equipment, or both.

FIG. 3 illustrates an example method of determining the master program start time for the television program being viewed when the program is received in analog format.

FIG. 4 illustrates an interactive TV integrator for use in the customer premises.

FIG. 5 illustrates various time stamps created for TV content for use and synchronization with interactive content associated with the TV content.

FIG. 6 illustrates the process of acquisition and synchronization of the interactive content with the television program.

### DETAILED DESCRIPTION OF THE INVENTION

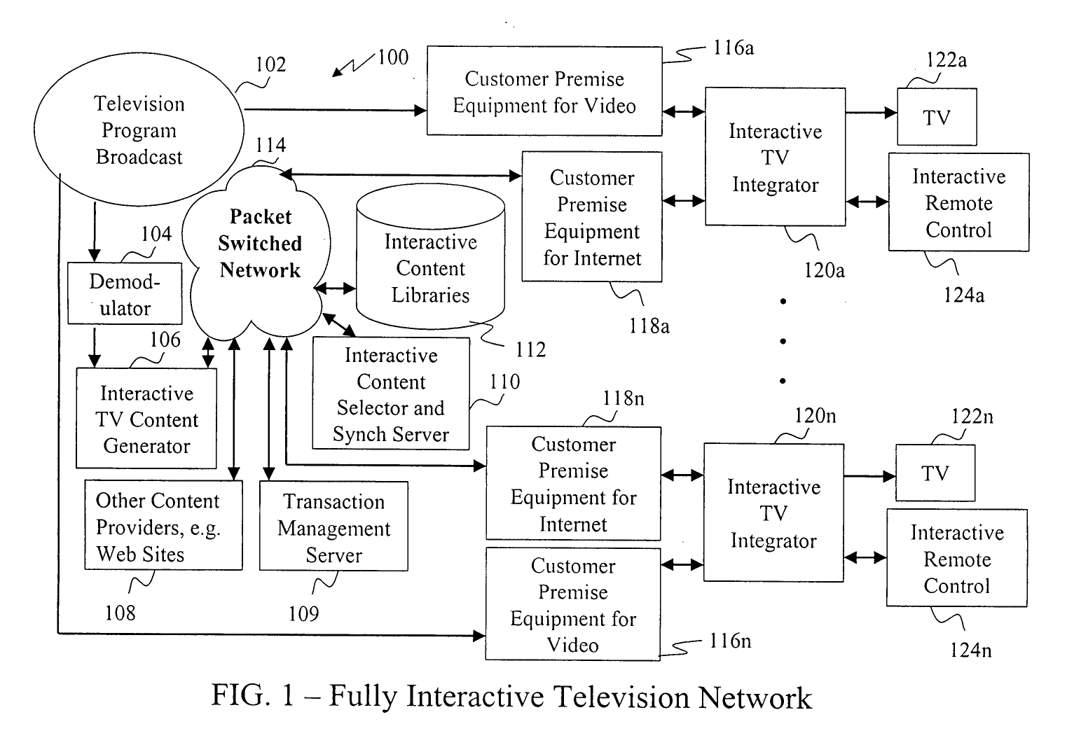

FIG. 1 shows a network 100 for provision of fully interactive television. Interactive content intended for integration with the television program and/or broadcast 102 is initially generated by the interactive TV content generator 106 and stored in the interactive content libraries 112. This interactive content is stored along with time stamps relating to the program start time and associated with events in the television program so that the interactive content may be synchronized to the television program. Events include, but are not limited to, words and sentences in the closed caption text of the program, video clip segment beginning and end, and so on.

The interactive content generator uses information contained in the television program, information previously stored in the interactive content libraries, and information from other content providers 108 to develop and synchronize candidate interactive content to the television program. If the interactive content must be purchased by the viewer, and/or if the interactive content contains opportunities for purchases based on the content, then the transaction management server 109 coordinates the billing and purchases of viewers, and also provides other customer fulfillment functions such as providing coupons, special discounts and promotions to viewers. During actual broadcast or playing of the interactive television program, the interactive content selector and synchronization server 110 uses information from other content providers such as interactive television program sponsors, and viewer preferences, history, and group viewer preferences to select the specific interactive content which is to be associated with the television program at a particular instant. The interactive content chosen by the content selector, which is synchronized to the television program via the synchronization server within it, is transmitted to the individual viewers via the packet switched network 114 and the customers' choices, preferences, and purchase particulars are also retained in the transaction management server and may be transmitted in part or in whole to interactive content providers 108 for the purpose of customer preference tracking, rewards, and customer fulfillment functions.

At the customer premises, the video reception equipment 116a receives the conventional television program, while the Internet equipment 118a receives the interactive content designed for, and synchronized to, the television program and customized for each individual viewer. The conventional video and interactive content are then integrated by the interactive TV integrator 120a for display on the customer's TV 122a and for interaction with the customer's interactive TV remote control 124. The interactive TV network simultaneously connects thusly to a plentitude of customer premises from one to n, as indicated by the customer premises equipment 116n through 124n. Thus, the interactive network shown in FIG. 1 simultaneously provides individualized interactive content to a plentitude of viewers that uses both previously developed interactive content as well as content developed during the program broadcast. The network therefore allows current television programming to be transformed into fully interactive and personalized interactive television via the devices shown in FIG. 1.

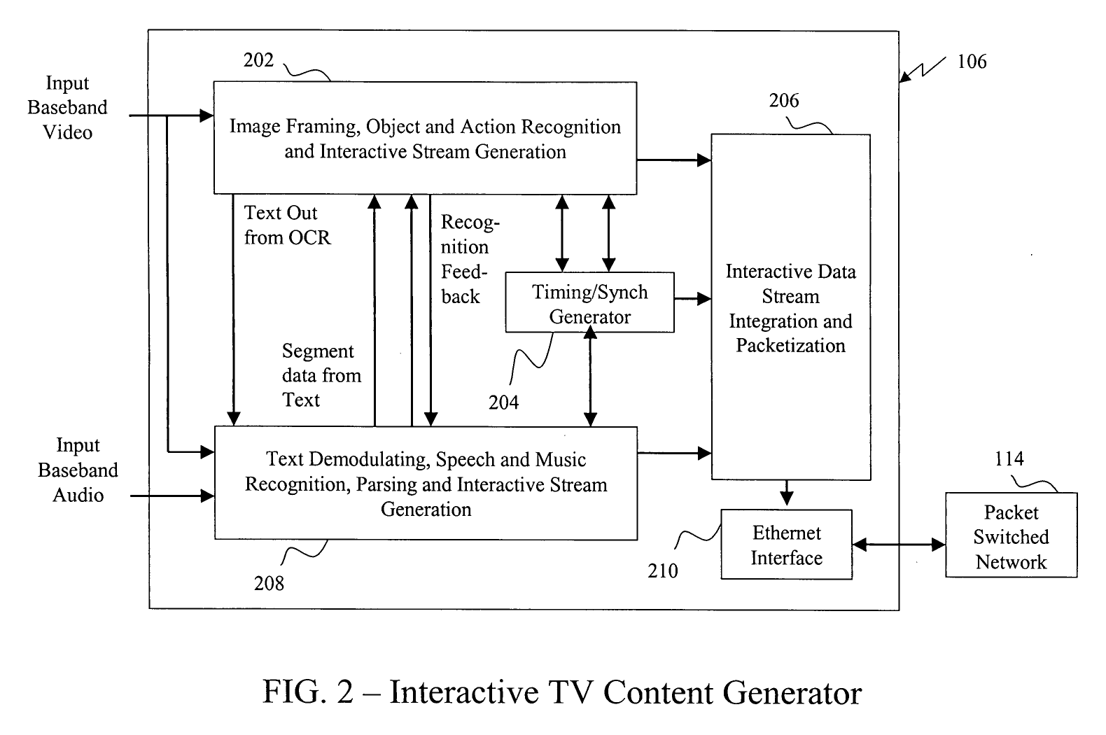

FIG. 2 depicts a block diagram of the interactive TV content generator 106 that develops interactive content streams and associates master time stamps with the interactive content streams from the television program either prior to, or during the broadcast of the television program. Typical television programs include image or frames, audio tracks, and text data sent either in the vertical blanking interval (VBI) of analog signals, or packetized in MPEG based digital video transmissions. These are the sources of, or pointers to interactive television content and synchronization time stamps that can be generated for the program. Thus, the input video and audio are processed to generate events in the television program that are synchronized to the television programming by the devices 202 and 208, and synchronized by the timing/synch generator 204. The timing/synch generator time stamps the interactive content generated by devices 202 and 208 using the time relative to the start time of the program, and these time stamps for each detected event in devices 202 and 208 are associated with the detected events when they are packetized in unit 206. The resulting streams are then passed to the interactive data stream integrator and packetizer 206, and are output to a packet switched network 114 via the Ethernet interface 210. The system shown in FIG. 2 provides a method and system for identifying all pertinent information in the television program that could be used for synchronization and viewer interaction. Examples include text of speech delivered in the program, identification of sounds and/or music in the program, identification of objects in the screen such as clothes, household items, cars, and other items typically purchased by viewers, and even actions ongoing in the program such as eating, drinking, running, swimming, and so on. All speech, sounds, screen objects, and actions are potential events that can be time stamped and thus are processed and identified by the system shown in FIG. 2 and have time stamps associated with them based on the time into the program where these events occur.

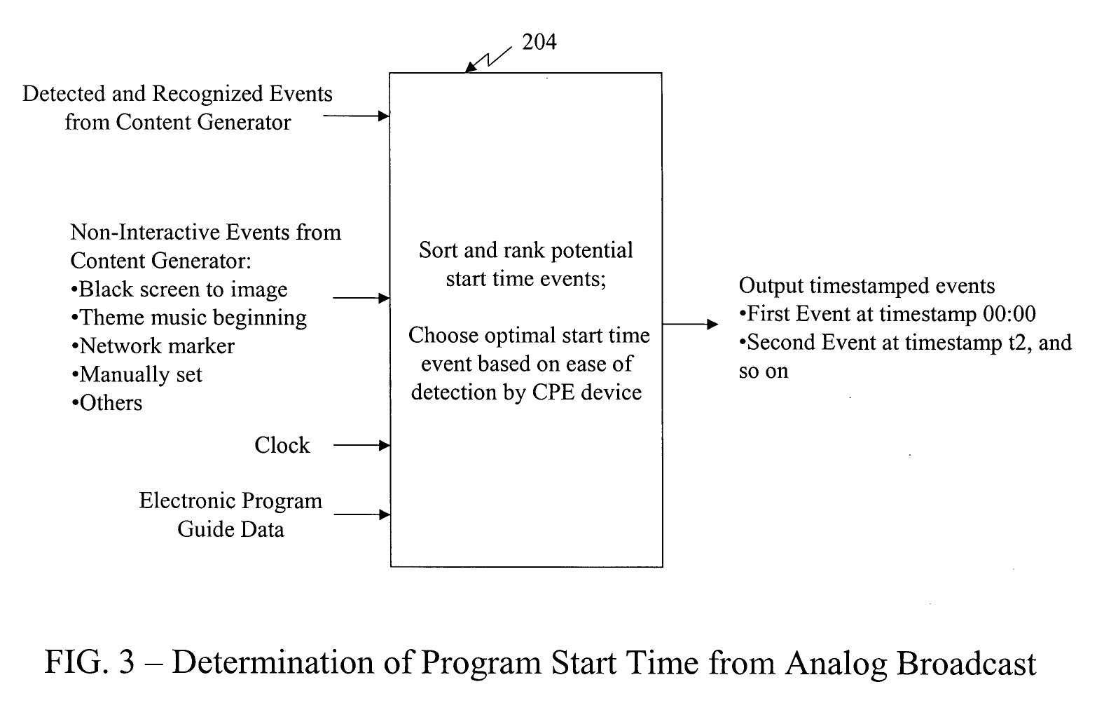

FIG. 3 depicts the method by which the program start time is determined by the timing/synch generator 204 in the interactive television content generator 106 from a television program that is initially received in analog format. The timing/synch generator receives information about the television program such as recognized objects, text, and events from the image and audio recognition subblocks 202 and 208, respectively, and further receives information about non-recognized objects such detection of black screen transition events, recognition of theme music, network audio, video, and/or RF markers found at the beginning of the program, a real time clock, electronic program guide data such as scheduled program start time, program duration, synopses, broadcast format, and other data, and finally a manual start time trigger set by a human operator watching the television program. These events are processed in the timing/synch generator in order to determine the earliest start time for the program that is easily detected and recognized by the customer premises equipment, which may have reduced performance implementations of the image, audio, and text recognition systems contained in the centralized version of the interactive content generator 106. The timing/synch generator then resets the time stamps of each detected event such that the time is relative to the selected start time of the program, and subsequent detections and recognitions of objects in the television program are all time stamped relative to the start time of the program.

Hence, during viewing of a television program that has been locally stored and synchronized to a master start time which is common to all CPE devices for that program, the viewer may pause, rewind, fast-forward, skip, and so on and the interactive content which is being integrated with the television program is modified so that the interactive content relevant to that segment of the program can be displayed to the viewer. This display can be outside of the television program viewing window on the screen, for example at the bottom and/or the sides of the screen, embedded within the television program, for example on top of recognized objects in the television program image, or any combination of these display methods. Since the interactive content is synchronized to the television program, navigation through the television program is akin to navigation through the interactive content associated with the television program. And at any later time when the program is viewed again, additional interactive content can be generated and viewed, since the first time the program was processed, the time stamps for objects and segments in the program were saved by the centralized system as well as the CPE devices when they stored it.

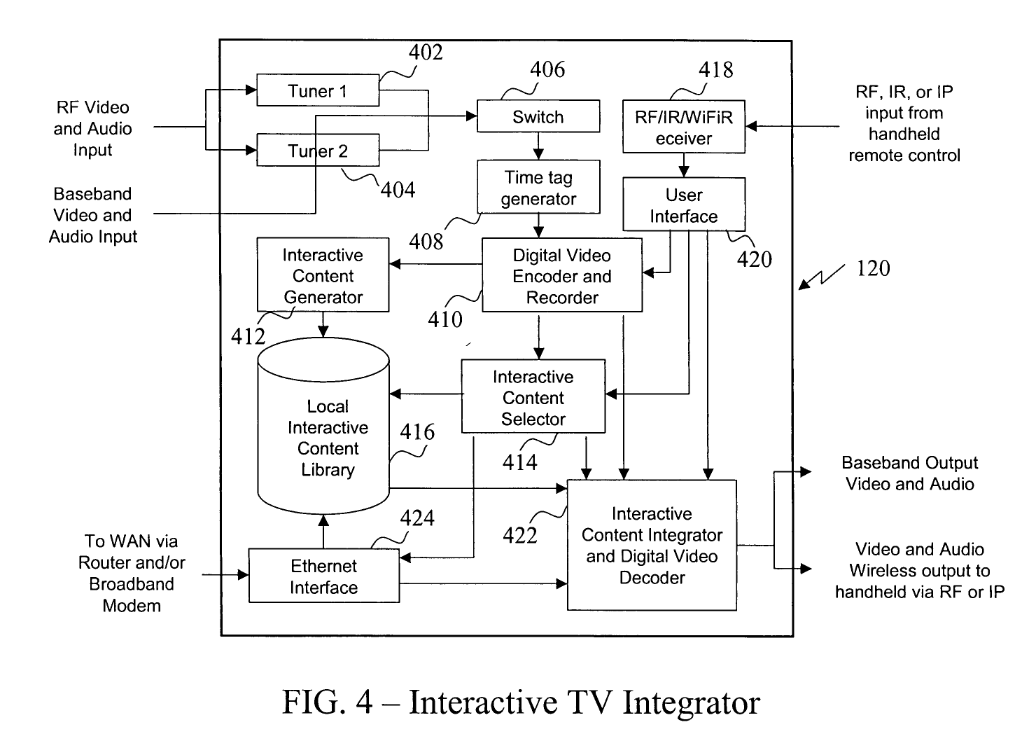

FIG. 4 shows an example interactive TV integrator that includes local versions of the interactive content generator 106, the interactive content libraries 112, and the interactive content ranking processor and selector 110. Since these versions are likely to be much smaller in scale and capability, they are renumbered as shown in the figure, but importantly, as the functions of the more capable centralized versions are migrated into the local versions, the interactive television network of the present invention has the capability to migrate from a centralized server architecture to a peer-to-peer network architecture where content can be stored primarily in customer premises, even though backups of the content will no doubt be archived centrally. Hence block 412 in the figure corresponds to block 106 previously, block 414 to block 110, and block 416 to block 112.

The RF video and audio are converted to baseband by the first tuner 402 and the second tuner 404 for passing to the switch 406. This RF video may be from any present source such as coaxial cable TV or off-air broadcast. Alternately, the baseband video and audio from a cable, satellite, or digital subscriber line (DSL) settop box may be input to the system directly and fed to the switch 406. Next time stamps are generated from the video and audio by a time tag generator 408. The time stamps are input along with the video and audio to a digital video recorder 410 for recording the television program along with time stamps. Initially, these time stamps are locally relevant only, and must be offset and/or corrected by a synchronization with the master time stamps generated by a centrally located content generator 106 and stored in a content library and synchronization server 112. The recorded digital video is provided to the interactive content generator 412, the content selector 414, and the interactive content integrator 422. The content generator works similarly to block 106 of FIG. 1, likewise the content selector is similar in function to block 110 of FIG. 1. The versions in the interactive TV integrator may have reduced functionality, however. And the interactive television content generated by 412 is sent to content libraries 416 which are similar to block 112 of FIG. 1 albeit reduced in scale, and the libraries are also fed by interactive television content received via packet switched network through the Ethernet interface 424. This Ethernet interface permits two-way, fully interactive applications to be delivered to the television viewer. For example, viewers may be offered an interactive application from an advertiser which when selected, activates a real time, two-way communications channel between the viewer (or multiple viewers) and the advertiser either directly, or via the transaction management server 109 for purposes of customer response and/or fulfillment. This real-time, two-way communications channel may be via conventional point and click, telephone conversation, videoconference, or any combination of the above. This two-way communications channel may also be implemented using conventional downstream and upstream communications channels on cable networks, for example, in which case the Ethernet interface 424 may not be necessary. Further, the real-time communications channel may be multipoint, as in a chat room, telephone conference call, or videoconference call. This two-way communications channel is also used for initial timing acquisition and synchronization with the synchronization server, as well as subsequent timing maintenance.

The viewer controls the interactive television integrator via the electronic receiver 418, which may use RF, IR, WiFi, or any combination thereof for signaling between the remote control and the interactive television integrator. Further, a camera, an infrared (IR) motion detector, and/or an RF tag sensor may also be used to provide viewer input 418 to the user interface 420. The interactive television integrator can then process viewer inputs and transmit them back to centrally located transaction management servers, interactive content selectors, and/or other content providers. This two way interactive communication channel can be used for viewer commands, voice or video telecommunications or conferencing, or for setting up viewer preferences and profiles. Note that these receivers and sensors may be external devices, or may be integrated within interactive television integrator.

The user interface block 420 controls the digital video recorder, the interactive content selector, and an interactive content integrator 422. The content integrator is where packet based interactive content generated locally or remotely and selected by the content selector is merged with the television programming and presented to the viewer either via baseband video and audio output, or via video and audio wireless IP streaming to a remote control, or both.

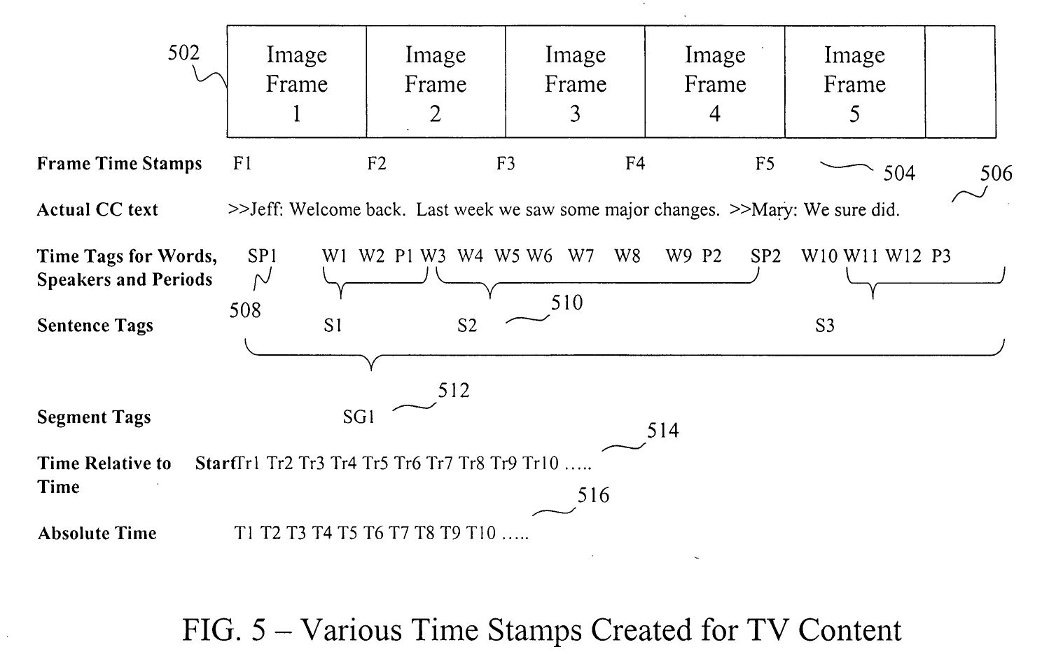

FIG. 5 shows the various timestamps created by the system when a new program is viewed. When the viewer selects a channel to be watched (or an automatic timer engages the system to record a particular program on a particular channel at a particular time), the interactive TV integrator initially creates local timestamps and associates them with the locally derived television program events as the program is recorded. These events are based on detected events in the image frame 502, strings of closed caption text 506, strings of text segments 508, complete text sentences 510, dialog segments 512, or can be based on other temporally varying features in the television broadcast. Meanwhile, the system begins identifying key events in the television signal, such as strings of closed caption text, show title and episode information, the beginning of theme music, and so on and creates absolute timestamps 516 associated with these events in the television program. If the system has already contacted the centrally located synchronization server 110, then the system also maintains a relative timestamp index 514 that is based on a global start time of the program, and is used for accessing interactive content in the television program.

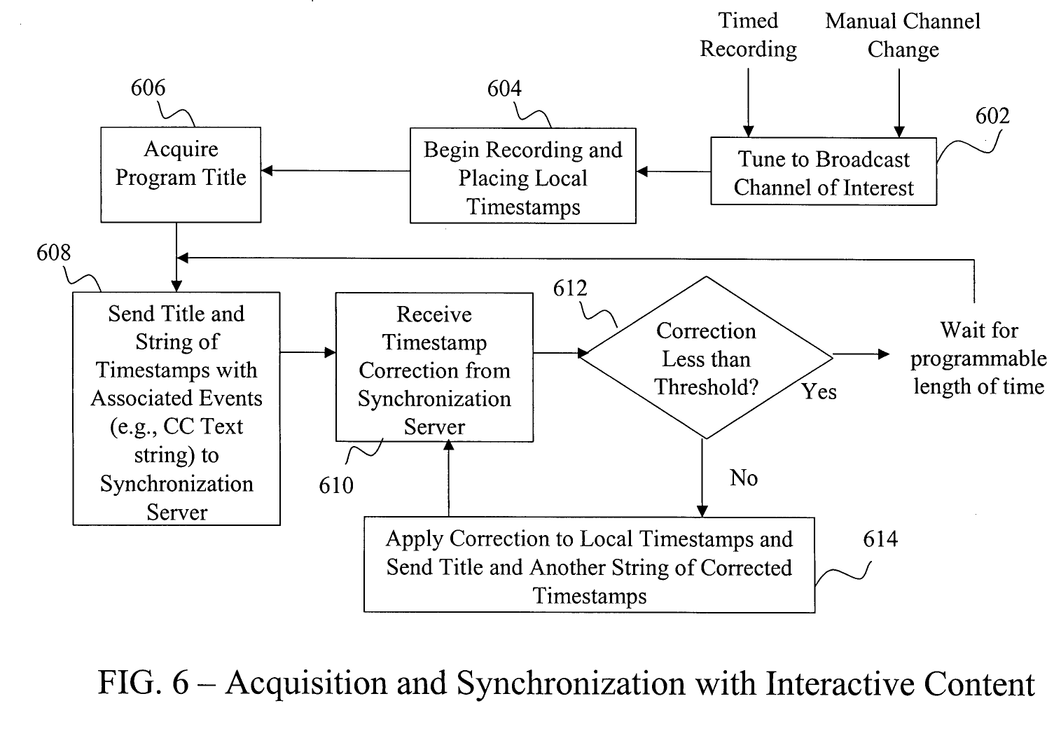

FIG. 6 depicts the process by which the interactive TV integrator synchronizes locally stored and played content with the centrally synchronization server 110 and thus with interactive content from the content libraries 112 and selected by the content selector 110. Initially a broadcast channel is tuned 602, either from the viewer manually selecting the channel, or from a recording timer automatically tuning to the channel and beginning recording of it. Local timestamps 516 are generated and stored with the recording 604. Next the system acquires the program title and information, either via electronic program guide via packet switched network, or via data contained in the broadcast. Next, the system captures a string of events in the program, such as a sequence of closed caption text or other events recognized in the television program video and audio, and timestamps them and then sends 608 them to the synchronization server 110 via packet switched network 114. The synchronization server, which also has stored events in the television program but such that they are time stamped using the master time reference for that program, then compares the CPE timestamps received from various systems, corrects them, and resends 610 them to the individual interactive TV integrators in the customer premises. The interactive TV integrator compares 612 the correction time offset to a predetermined threshold, and if less than the threshold, sets a flag indicating the interactive content has been synchronized with the program, and then waits a programmable amount of time before performing another synchronization cycle as part of maintaining synchronization during the television program. If the correction is above a predetermined threshold, the interactive TV integrator captures a second set of events, applies the corrected timestamps and sends them 614 back to the synchronization server 110 to continue the synchronization process until the correction is below a predetermined threshold.

The synchronization system uses events detected throughout the television program to continue to maintain synchronization with customer premises equipment (CPE) and to segment the program so that interactive content associated with each segment can be made available when that segment is being played, either for the first time or at subsequent playings. Events that are detected by the content generator can be from the video, audio, or data contained within the television signal such as closed caption text. Video events include, but are not limited to: 1) object recognition in image frames, where the first instance of the object defines a segment start time and the last contiguous instance of that object defines a segment end time; 2) video signal level changes such as going from an all black screen to one that contains a brightness level above a predefined threshold; 3) detected and recognized text information in the video stream itself, such as news and advertising banners at the bottom of the screen, and text information windows throughout the screen; 4) statistics and parameters of the video sampled and processed by unit 202, such as color content, brightness level, and detected motions and actions in the video such as explosions, fight scenes, and so on; and 5) statistics and parameters of the compressed video stream such as bandwidth vs. time, statistics of MPEG frame types, edge detection statistics, and data embedded within the MPEG video stream. Audio events include, but are not limited to: 1) speech recognition results of audio track, recognized audio events such as explosions, gun shots, laser blasts, and so on; 2) sound level changes above and below predetermined thresholds, or matching predetermined patterns of change in sound level; 3) matching predetermined specific audio tracks such as theme and atmosphere music commonly used for the program being viewed; 4) statistics and parameters of the audio track sampled and processed by unit 208, including frequency domain analysis via fast Fourier transform (FFT), wavelet transform, or other transform domain processing designed to improve identification of features in audio signals; 5) statistics and parameters of the compressed audio track such as bandwidth vs. time. Finally, the television program, if already digital when initially received, will contain embedded data associated with the program, and this data can be integrated with the other event data generated by the system of the present invention in order to identify objects, text, and events in the video for segmentation, synchronization, and tracking of interactive content.

The system also includes programmable values for parameters such as the time between synchronization maintenance requests, maximum number of attempts to synchronize or resynchronize, and other parameters that permit the system to trade off performance for bandwidth requirements in the network.

An example implementation of the synchronization process is as follows: A television program is digitized and recorded to computer hard disk using any of a number of current personal video recorder technologies that are commercially available. In this example, the recording begins 90 seconds before the actual TV program begins. After recording the entire TV program, including commercial breaks that vary in number and duration from CPE to CPE, the file containing the recorded TV program is processed to determine the actual start time of the TV program. In this example, the start time is determined by first detecting the time at which the TV program theme music begins; this is accomplished by correlating the sampled audio from the recorded TV program with a locally stored version of the theme music audio sent to the CPE via packet switched network. Next, the start time of the actual TV program, which in this example is 90 seconds into the recording, is determined by a combination of analyzing the closed caption text (if available) prior to the beginning of the theme music, or by analyzing the digital frames of the recorded video and looking for identifiable frames such as a black frame prior to TV program start, a commonly occurring image at the beginning of the TV program, or a logo or other text information indicating the TV program name commonly placed at the bottom right portion of the screen by TV networks at the beginning of the TV program. At this point, it is determined by the system of the present invention that the actual TV program begins 90 seconds into the recorded file containing the TV program, and from then on, the timing information to be used by the system for synchronization of interactive content sent via packet switched network with the TV program is merely the number of seconds into the recording minus 90. The number of seconds into the recording is commonly available from digital video player software. The same system can be used by another CPE where the TV program was recorded along with a previous program, yielding an offset of approximately 60 minutes (3600 seconds) in the latter case. The interactive content itself is then synchronized to the TV program by using a simple file structure that contains the time into the TV program where the interactive content is to be initially available to the viewer, and either the interactive content, or a pointer to the content such as a local file location, web address or universal resource locator (URL).

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A system and method for synchronization and integration of customized interactive content with analog or digital television programming comprising:.
analysis and encoding of television programming to support integration and synchronization of local and remote interactive content,
encoding and digital storage of television programming to support time-shifting and user controlled playback while maintaining synchronization with local and remote interactive content.

2. The system of claim 1, using a either analog television programming sources, digital television programming sources, live television programming sources, television content delivered via packet switched networks, or recorded television programming sources

3. The system of claim 1, using either over-the-air delivery of analog television programming, over-the-air delivery of digital television programming, cable delivery of analog television programming, cable delivery of digital television programming, satellite delivery of digital television programming, or packet switched network delivery of digital television programming, or any combination thereof.

4. The system of claim 1, using the VBI data stream for program segmentation and time stamp generation.

5. The system of claim 1, using an electronic program guide and current date and time for program segmentation and time stamp generation.

6. The system of claim 1, using the VBI data stream and an electronic program guide for program segmentation and time stamp generation.

7. The system of claim 1, using audio attributes of the television program for segmentation and time stamp generation.

8. The system of claim 1, using video attributes of the television program for segmentation and time stamp generation.

9. The system of claim 1, using audio and/or video attributes of the television program for segmentation and time stamp generation.

10. The system of claim 1, using digital video data items contained within the television program for segmentation and time stamp generation.

11. The system of claim 1, using audio and/or video attributes of the television program and/or digital video data items contained within the television program for segmentation and time stamp generation.

12. The system of claim 1, using a combination of the VBI data stream, an electronic program guide, audio and video attributes of the television program, and digital video data items contained within the program for program segmentation and time stamp generation.

13. The system of claim 1, where interactive content is generated and stored locally.

14. The system of claim 1, where interactive content is received from a remote system via a packet switched network.

15. The system of claim 1, where interactive content is provided via a combination of locally generated and stored content and content received from a remote system via a packet switched network.

16. The system of claim 1, where playback of interactive content is closely synchronized with the television program display.

17. The system of claim 1, where the playback of interactive content is loosely synchronized with the television program display.

18. The system of claim 1, where the playback of interactive content is asynchronous and independent from the television program display.

19. The system of claim 1, where playback of interactive content is provided by a combination of content that is closely synchronized with the television program display, content that is loosely synchronized with the television program display, and content that is asynchronous and independent of the television program display.

20. The system of claim 1, using a combination of the VBI data stream, an electronic program guide, audio and video attributes of the television program, and digital video data items contained within the program for program segmentation and time stamp generation, and further wherein interactive content is provided via a combination of locally generated and stored content and content received from a remote system via a packet switched network, and further wherein playback of interactive content is provided by a combination of content that is closely synchronized with the television program display, content that is loosely synchronized with the television program display, and content that is asynchronous and independent of the television program display.
